(19) United States
(12) Patent Application Publication
(10) Pub. No.: US 2023/0055914 A1
(43) Pub. Date: Feb. 23, 2023

(54) SECONDARY BATTERY

(71) Applicant: TOYOTA JIDOSHA KABUSHIKI KAISHA, Toyota-shi Aichi-ken (JP)

(72) Inventor: Kentaro Suzuki, Toyota-shi Aichi-ken (JP)

(73) Assignee: TOYOTA JIDOSHA KABUSHIKI KAISHA, Toyota-shi Aichi-ken (JP)

(21) Appl. No.: 17/876,039

(22) Filed: Jul. 28, 2022

(30) Foreign Application Priority Data
Aug. 17, 2021 (JP) 2021-132650

(51) Int. Cl. H01M 50/148; H01M 50/172; H01M 50/188

(52) U.S. Cl. CPC H01M 50/154; H01M 50/172; H01M 50/188

(57) ABSTRACT

A secondary battery includes: a case member; a cover member having a through-hole and configured to close an opening of the case member; a terminal member passed through the through-hole; and a sealing member configured to close a gap between the cover member and the terminal member. The sealing member includes: an exposed end portion placed to be exposed inside the case member; and an extending portion extending from the exposed end portion toward the position of the through-hole. The cover member includes a first surface portion. The terminal member includes a second surface portion placed to face the first surface portion via a distance. The first surface portion and the second surface portion are placed to compress the extending portion. The distance between the first surface portion and the second surface portion increases toward the position of the exposed end portion.

### CROSS-REFERENCE TO RELATED APPLICATION

This application claims priority to Japanese Patent Application No. 2021-132650 filed on Aug. 17, 2021, incorporated herein by reference in its entirety.

### BACKGROUND

### 1. Technical Field

This disclosure relates to a secondary battery.

### 2. Description of Related Art

As described in Japanese Unexamined Patent Application Publication No. 2014-029839 (JP 2014-029839 A), a general secondary battery includes a housing, an electrode body, an electrolytic solution, and a terminal member. The electrode body is accommodated inside the housing together with the electrolytic solution. The terminal member is connected to the electrode body and is placed to penetrate through a cover member of the housing. The cover member of the housing has a through-hole, and the terminal member is passed through the through-hole. A sealing member is provided between the cover member and the terminal member. When the sealing member is compressed between the cover member and the terminal member, sealability in the through-hole is secured.

### SUMMARY

When the sealing member is provided between the cover member and the terminal member and is placed such that the sealing member is compressed, frictional force is caused between the sealing member and the cover member. The sealing member swells by making contact with the electrolytic solution inside the housing of the secondary battery. In a case where the sealing member is compressed inside the secondary battery, and the sealing member swells in a compressed state, the sealing member creates an over-compressed state. As a result, cracks are formed in the sealing member, so that the sealability in the through-hole might decrease. Such an event might be more likely to occur in a case where the compressibility of the sealing member increases or the frictional force between the sealing member and the cover member increases so as to obtain high sealability.

An object of this disclosure is to provide a secondary battery having a configuration that can restrain a decrease in sealability between a cover member and a terminal member by a sealing member.

A secondary battery according to this disclosure includes an electrode body, an electrolytic solution, a case member, a terminal member, and a sealing member. Inside the case member, the electrode body and the electrolytic solution are accommodated, and the case member has an opening. The cover member has a through-hole, and the cover member is placed to close the opening of the case member. The terminal member is electrically connected to the electrode body inside the case member. The terminal member is passed through the through-hole such that the terminal member is extended outwardly from the cover member. The sealing member is placed to close a gap between the cover member and the terminal member. The sealing member is configured to prevent the inside of the case member from communicating with the outside of the case member via the through-hole. The sealing member includes an exposed end portion placed to be exposed inside the case member, and an extending portion extending from the exposed end portion toward a position of the through-hole. The extending portion is compressed by the cover member and the terminal member. The cover member includes a first surface portion. The terminal member includes a second surface portion placed to face the first surface portion via a distance. The first surface portion and the second surface portion are placed to compress the extending portion. The distance between the first surface portion and the second surface portion increases toward a position of the exposed end portion.

In the secondary battery, the sealing member may be made of fluoro rubber.

In the secondary battery, the terminal member may include a connecting portion passed through the through-hole, and a flange portion provided at a position of a part of the connecting portion, the part being placed inside the case member. The second surface portion is formed on the flange portion. The second surface portion of the flange portion may be formed in a shape of a tapered surface. The tapered surface may be formed such that a distance between the tapered surface and the first surface portion increases as the tapered surface is distanced from the connecting portion.

In the secondary battery, the sealing member may include a tubular portion placed between the through-hole and the connecting portion. The tubular portion may be configured to surround the connecting portion. The extending portion may be provided in a part of the tubular portion, the part being placed inside the case member.

With this disclosure, it is possible to provide a secondary battery having a configuration that can restrain a decrease in sealability between a cover member and a terminal member by a sealing member.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view illustrating an internal structure of a secondary battery 10 according to an embodiment;

FIG. 2 is a sectional view illustrating a region surrounded by a line II in FIG. 1 in an enlarged manner;

FIG. 3 is a sectional view illustrating a sealing member 50;

FIG. 4 is a sectional view illustrating a state where the sealing member 50 in FIG. 2 swells and a surrounding structure around the sealing member 50;

FIG. 5 is a sectional view illustrating a state where the sealing member 50 swells;

FIG. 6 is a sectional view illustrating a terminal member 40Z provided in a secondary battery in a comparative example and a surrounding structure around the terminal member 40Z;

FIG. 7 is a sectional view illustrating a state where the sealing member 50 provided on the terminal member 40Z of the secondary battery in the comparative example swells and a surrounding structure around the sealing member 50;

FIG. 8 is a sectional view illustrating a region surrounded by a line VIII in FIG. 7 in an enlarged manner;

FIG. 9 is a sectional view illustrating a state where a sealing member 90 placed on a deformation restriction member 80a swells;

FIG. 10 is a sectional view illustrating a state where the sealing member 90 placed on a deformation restriction member 80b swells;

FIG. 11 is a sectional view illustrating a state where the sealing member 90 placed on a deformation restriction member 80c swells;

FIG. 12 is a sectional view illustrating a state where the sealing member 90 placed on a deformation restriction member 80d swells;

FIG. 13 is a graph illustrating how respective compressibilities of the sealing member based on the embodiment and the sealing member based on the comparative example change over time; and

FIG. 14 is a sectional view to describe parameters of various dimensions and angles applicable to a second surface portion S2 of a terminal member 40 and a surrounding structure around the second surface portion S2.

### DETAILED DESCRIPTION OF EMBODIMENTS

### Embodiment

A secondary battery 10 according to an embodiment will be described below with reference to the drawings. In a case where a number, an amount, a quality of material, and the like are mentioned in the following description, the scope of this disclosure is not necessarily limited to the number, the amount, the quality of material, and the like, unless otherwise specified. The same reference numeral is assigned to identical components and equivalent components, and redundant descriptions may be omitted. It is planned from the first to use appropriate combinations of configurations in the embodiment. Dimension relationships such as length, width, thickness, and depth are changed appropriately for clarification and simplification of the drawings and do not represent actual dimension relationships.

Secondary Battery 10

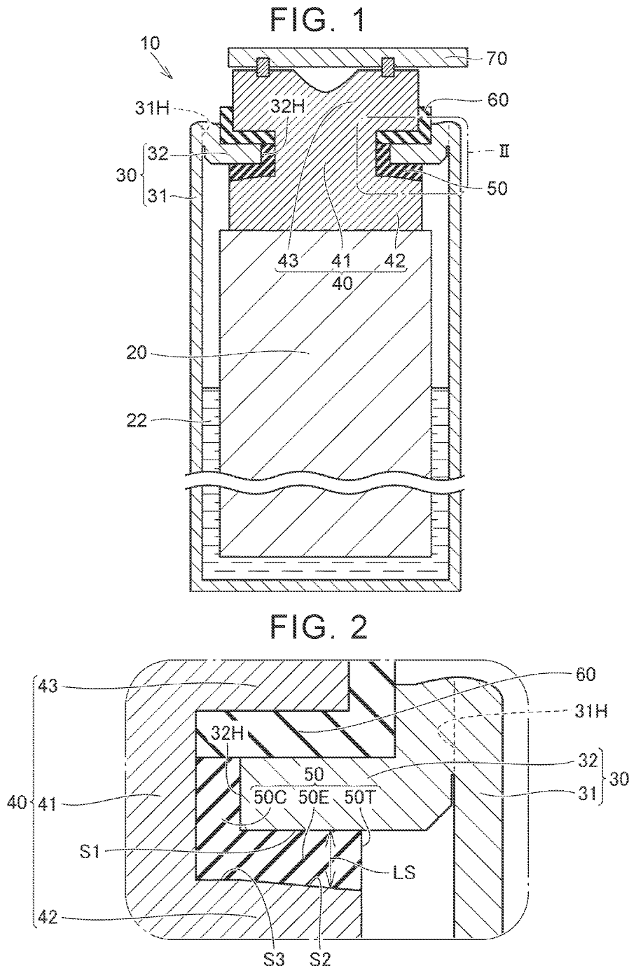

FIG. 1 is a sectional view illustrating an internal structure of the secondary battery 10 according to the embodiment. FIG. 2 is a sectional view illustrating a region surrounded by a line II in FIG. 1 in an enlarged manner.

The secondary battery 10 (FIG. 1) is a nonaqueous electrolyte secondary battery such as a lithium-ion secondary battery. One assembled battery is constituted by combining a plurality of secondary batteries 10 in series and/or in parallel. The secondary battery 10 is provided, for example, in a hybrid electric vehicle, a plug-in hybrid electric vehicle, a fuel cell electric vehicle, and a battery electric vehicle such that the secondary battery 10 is used as a power source for such vehicles. The technical idea of this disclosure is not limited to the nonaqueous electrolyte secondary battery and is also applicable to secondary batteries other than the nonaqueous electrolyte secondary battery. Further, the purpose of use of this disclosure is not limited to automobiles and is applicable to various technical fields.

As illustrated in FIG. 1, the secondary battery 10 includes an electrode body 20, an electrolytic solution 22, a housing 30, a terminal member 40, a sealing member 50, an insulating member 60, and a bus bar 70. The electrode body 20 is configured such that a positive electrode, a negative electrode, and a separator are laminated or wound, and the electrode body 20 functions as a power generation element. Inside the housing 30, the electrode body 20 is impregnated with the electrolytic solution 22.

The housing 30 includes a case member 31 and a cover member 32. The case member 31 has an opening 31H and is formed into a square shape as a whole. Inside the case member 31, the electrode body 20 and the electrolytic solution 22 are accommodated. The cover member 32 has a flat-plate shape, and the cover member 32 has an outer shape (e.g., a rectangular shape) corresponding to the opening 31H of the case member 31.

The cover member 32 is joined to the case member 31 by welding such that the cover member 32 is placed to close the opening 31H of the case member 31. In FIGS. 1, 2, and so on, the cover member 32 is joined to a part of the case member 31 that corresponds to the opening 31H, so that the cover member 32 is integrated with the case member 31. The cover member 32 has a through-hole 32H. The through-hole 32H penetrates through the cover member 32 in the thickness direction of the cover member 32, so that the terminal member 40 can be passed through the through-hole 32H.

The terminal member 40 is electrically connected to the electrode body 20 inside the case member 31 and is also passed through the through-hole 32H such that the terminal member 40 is extended outwardly from the cover member 32. Although detailed illustrations are omitted herein, the secondary battery 10 is provided with two terminal members 40. One of the terminal members 40 is connected to a positive electrode of the electrode body 20, and the other one of the terminal members 40 is connected to a negative electrode of the electrode body 20. As materials for the terminal members 40, aluminum can be employed for the terminal member 40 on the positive electrode side, and copper can be employed for the terminal member 40 on the negative electrode side, for example.

The terminal member 40 includes a connecting portion 41, a flange portion 42, and a caulking portion 43. The connecting portion 41 has a columnar shape. The connecting portion 41 is passed through the through-hole 32H of the cover member 32 such that the connecting portion 41 is extended outwardly (upward) from the cover member 32. The flange portion 42 is provided at a position of a part of the connecting portion 41 that is placed inside the case member 31 such that the flange portion 42 is placed to face the cover member 32 from inside the case member 31 (from an inner surface side of the cover member 32). The caulking portion 43 is provided at a position of a part of the connecting portion 41 that is placed outside the case member 31.

The bus bar 70 is electrically connected to a part of the terminal member 40 that projects outwardly from the secondary battery 10, for example. The bus bar 70 and the terminal member 40 function as an electric current path and are used to take out electric power stored in the electrode body 20 to outside the secondary battery 10 and to introduce electric power into the electrode body 20 from outside the secondary battery 10.

As illustrated in FIG. 2, the sealing member 50 is placed to close a gap between the cover member 32 and the terminal member 40 together with the insulating member 60. The sealing member 50 and the insulating member 60 are both made of resin, for example, and are configured to prevent the inside of the housing 30 (the case member 31) from communicating with the outside of the housing 30 (the case member 31) via the through-hole 32H. The insulating member 60 is placed on the outer side of the housing 30 when the insulating member 60 is viewed from the through-hole 32H. The insulating member 60 is placed between the outer surface (the upper face) of the cover member 32 and the caulking portion 43 of the terminal member 40 and electrically insulates the terminal member 40 from the cover member 32 in collaboration with the sealing member 50.

The sealing member 50 is placed on the inner side of the housing 30 when the sealing member 50 is viewed from the through-hole 32H. As the material for the sealing member 50, a material having a high-temperature creep characteristic, that is, a material that can achieve a long-term creep resistance to a heat and cold cycle of the secondary battery 10 can be used. In consideration of synthetic resin being expensive, fluoro rubber (vinylidene-fluoride-based rubber: FKM) can be used as the material for the sealing member 50. As the sealing member, a resin material within a range of 0.01 GPa to 5 GPa or a composite material of resin and fiber may be used, for example. As the sealing member, polyamide 66 (PA66), a tetrafluoroethylene perfluoroalkyl vinyl ether copolymer (PFA), or the like can be used.

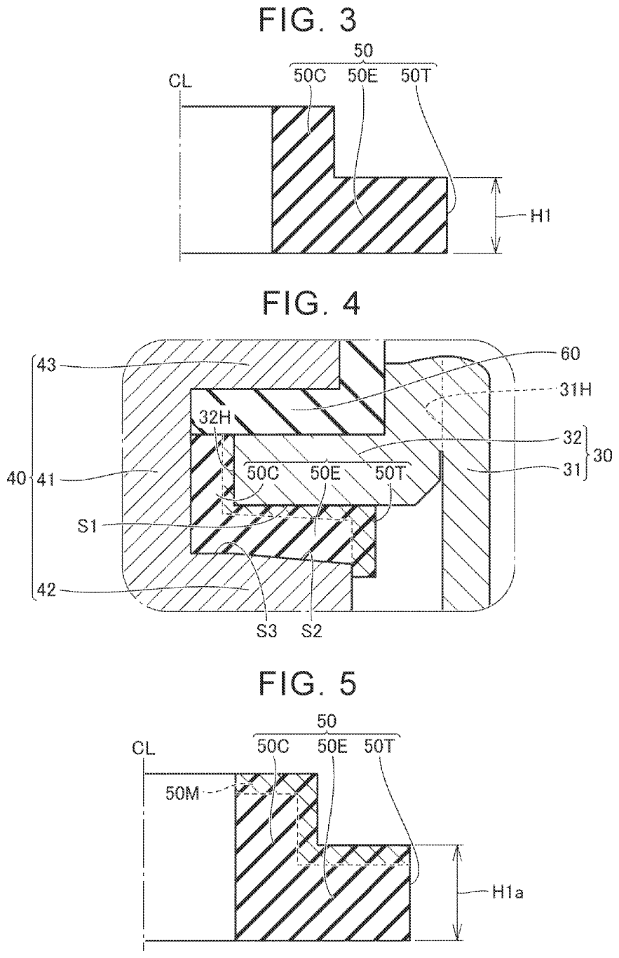

FIG. 3 is a sectional view illustrating the sealing member 50. The sealing member 50 includes a tubular portion 50C, an exposed end portion 50T, and an extending portion 50E. The tubular portion 50C is formed into a tubular shape having a virtual axis CL as a tubular axis. The tubular portion 50C is provided to surround the connecting portion 41 (FIG. 2) of the terminal member 40 and is placed inside the through-hole 32H of the cover member 32 (at a position on the inside-diameter side of the through-hole 32H). Stated differently, the tubular portion 50C of the sealing member 50 is provided between an inner peripheral surface of the cover member 32 that forms the through-hole 32H and an outer peripheral surface of the connecting portion 41. The tubular portion 50C electrically insulates an inner peripheral surface part of the cover member 32 that forms the through-hole 32H from the connecting portion 41.

The extending portion 50E has a flat-plate shape the center of which is hollowed (that is, a part corresponding to the tubular portion 50C) and extends in a direction intersecting with the virtual axis CL, herein, in a direction perpendicular to the virtual axis CL. The extending portion 50E is provided at a position of a part of the tubular portion 50C that is placed inside the case member 31. In a case where the extending portion 50E is viewed from a direction parallel to the virtual axis CL (FIG. 3), the outer shape of the extending portion 50E is a circular shape or a rectangular shape, for example. An inner end portion (an inside-diameter-side end portion) of the extending portion 50E is continuous with the tubular portion 50C. The exposed end portion 50T is provided at a position on the opposite side of the extending portion 50E from the tubular portion 50C.

The exposed end portion 50T corresponds to an outer peripheral portion of the extending portion 50E. In a case where the exposed end portion 50T is viewed from a direction parallel to the virtual axis CL (FIG. 3), the exposed end portion 50T extends to surround the virtual axis CL in a circular shape or a rectangular shape, for example. The exposed end portion 50T is placed in an exposed manner inside the case member 31, more specifically, in an internal space of the case member 31 where the exposed end portion 50T can make contact with the electrolytic solution 22.

The extending portion 50E is placed to extend from the exposed end portion 50T to toward the position of the through-hole 32H. The extending portion 50E is compressed by a surface (an inner surface) of the cover member 32 that faces the inner side of the case member 31 and the terminal member 40 (the flange portion 42). The extending portion 50E insulates the surface of the cover member 32 that faces the inner side of the case member 31 from the terminal member 40 (the flange portion 42).

Here, the inner surface of the cover member 32 (more specifically, the surface of the cover member 32 that faces the inner side of the case member 31) includes a first surface portion S1. In the meantime, the terminal member 40 (more specifically, the flange portion 42) includes a second surface portion S2 placed to face the first surface portion S1 via a distance LS. The first surface portion S1 and the second surface portion S2 are placed on the opposite sides of the extending portion 50E and are placed to compress the extending portion 50E in the up-down direction.

The distance LS between the first surface portion S1 and the second surface portion S2 increases as it approaches the position of the exposed end portion 50T. The distance LS is relatively short on a side close to the through-hole 32H and the tubular portion 50C and is relatively long on a side close to the exposed end portion 50T.

Here, the second surface portion S2 is formed on the flange portion 42 of the terminal member 40. The second surface portion S2 of the flange portion 42 is formed in a shape of a tapered surface. The tapered surface is formed such that the distance (the distance LS) between the tapered surface and the first surface portion S1 increases as it is distanced from the connecting portion 41. The surface shape of the tapered surface in the second surface portion S2 may be a two-dimensional flat-surface shape, may be a three-dimensional curved-surface shape, or may be a combination of them.

A third surface portion S3 is provided on the inside-diameter side of the second surface portion S2. The third surface portion S3 makes contact with the tubular portion 50C of the sealing member 50 from a position inside the housing 30. In the example illustrated in FIG. 2, the third surface portion S3 extends in parallel to the first surface portion S1 of the cover member 32. The third surface portion S3 is not limited to such a configuration. The third surface portion S3 may be provided to be inclined from the first surface portion S1 such that the third surface portion S3 is placed on the same plane as the second surface portion S2. The third surface portion S3 may be provided to have an inclination angle the same as or equivalent to the inclination angle of the second surface portion S2 from the first surface portion S1.

Operations and Effects

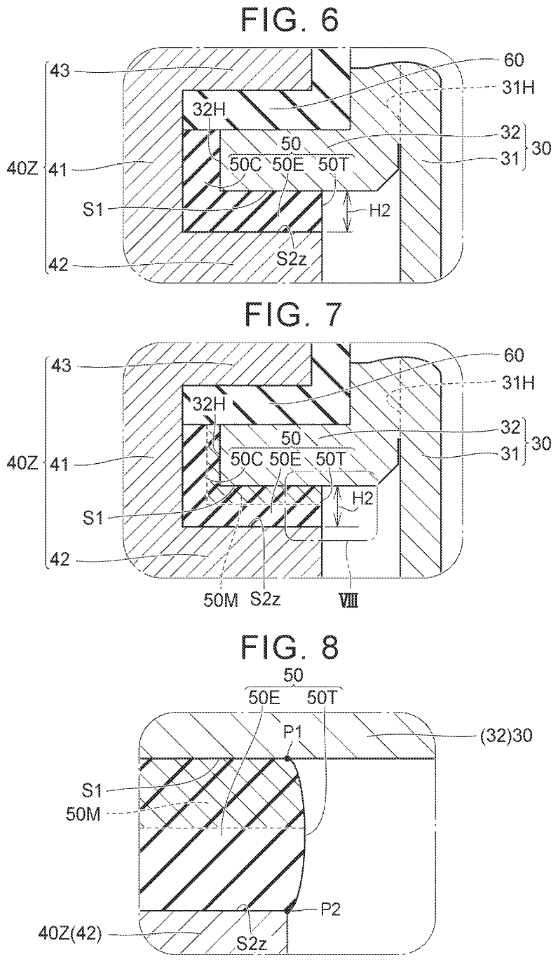

FIG. 4 is a sectional view illustrating a state where the sealing member 50 in FIG. 2 swells and a surrounding structure around the sealing member 50. Operations and effects to be achieved by the secondary battery 10 in the present embodiment will be described below with reference to a comparative example illustrated in FIGS. 6, 7 and so on.

As described in the beginning of the present specification, the sealing member 50 (FIG. 4) is provided between the cover member 32 and the terminal member 40, and the sealing member 50 is placed to be compressed, so that frictional force is caused between the sealing member 50 and the cover member 32. In the secondary battery 10, frictional force is caused between the first surface portion 51 of the cover member 32 and the extending portion 50E of the sealing member 50, and further, frictional force is caused between the second surface portion S2 of the flange portion 42 and the extending portion 50E of the sealing member 50.

FIG. 5 is a sectional view illustrating a state where the sealing member 50 swells. The sealing member 50 swells by making contact with the electrolytic solution 22 (FIG. 1) inside the housing 30 of the secondary battery 10. The sealing member 50 includes a swelling portion 50M. The extending portion 50E of the sealing member 50 has a thickness H1 in a state before the sealing member 50 swells, whereas the extending portion 50E of the sealing member 50 has a thickness H1a in a state after the sealing member 50 swells. The thickness H1a is larger than the thickness H1 just by the swelling portion 50M.

FIG. 6 is a sectional view illustrating a terminal member 40Z provided in a secondary battery in a comparative example and a surrounding structure around the terminal member 40Z. FIG. 7 is a sectional view illustrating a state where the sealing member 50 provided on the terminal member 40Z of the secondary battery in the comparative example swells and a surrounding structure around the sealing member 50. In the comparative example illustrated in FIGS. 6, 7, the first surface portion S1 is parallel to a second surface portion S2z, and the distance between the first surface portion S1 and the second surface portion S2z does not change even at a position closer to the exposed end portion 50T of the sealing member 50 (the distance is kept as the same value).

It is assumed that the sealing member 50 is compressed inside the secondary battery 10, and the sealing member 50 swells to such an extent that the sealing member 50 exceeds a predetermined amount in a compressed state. Generally, even in a state where the sealing member 50 does not swell or in a state where the sealing member 50 swells, a distance H2 (FIGS. 6, 7) between the first surface portion 51 and the second surface portion S2 (S2z) hardly changes. Accordingly, as the sealing member 50 swells, a compression amount of the sealing member 50 increases.

FIG. 8 is a sectional view illustrating a region surrounded by a line VIII in FIG. 7 in an enlarged manner. In the comparative example illustrated in FIGS. 6 to 8, the first surface portion S1 is parallel to the second surface portion S2z. Frictional force between the extending portion 50E of the sealing member 50 and the first surface portion 51 of the cover member 32 is larger than that in the case of the above embodiment. Further, frictional force between the extending portion 50E of the sealing member 50 and the second surface portion S2z of the flange portion 42 is also larger than that in the case of the above embodiment.

In a case where the sealing member 50 swells, a part P1 of the extending portion 50E of the sealing member 50 that makes contact with the first surface portion S1 is hard to move toward the exposed end portion 50T side in a right lateral direction on the plane of paper of FIG. 8 (in comparison with the case of the embodiment). Similarly, in the case where the sealing member 50 swells, a part P2 of the extending portion 50E of the sealing member 50 that makes contact with the second surface portion S2 is hard to move toward the exposed end portion 50T side in the right lateral direction on the plane of paper of FIG. 8 (in comparison with the case of the embodiment). In a case where the sealing member 50 swells, the sealing member 50 in the comparative example is hard to deform in such a manner that the volume of the sealing member 50 swells.

Accordingly, the sealing member 50 creates an over-compressed state, and as a result, cracks are formed in the sealing member 50, so that the sealability in the through-hole 32H might decrease. Such an event might be more likely to occur in a case where the compressibility of the sealing member 50 is made higher or the frictional force between the sealing member 50 and the cover member 32 is made larger so as to obtain high sealability.

In order to deal with a fact that the above event might occur in the comparative example, the secondary battery 10 of the embodiment is configured such that the distance LS between the first surface portion S1 and the second surface portion S2 increases at a position closer to the exposed end portion 50T of the sealing member 50, as illustrated in FIG. 4.

A structure where the frictional force is reduced is provided, and therefore, even in a case where the sealing member 50 swells, a part of the sealing member 50 (that is, the extending portion 50E) between the first surface portion S1 and the second surface portion S2 easily deforms in such a manner that the volume of the sealing member 50 swells toward the exposed end portion 50T side in the right lateral direction on the plane of paper of FIG. 4 (in comparison with the case of the comparative example).

As a result, the sealing member 50 can deform to project outwardly from a part between the first surface portion S1 and the second surface portion S2, and eventually, it is possible to effectively restrain the compression amount of the sealing member 50 from increasing to be more than a predetermined amount. The sealing member 50 is restrained from creating an over-compressed state, and eventually, it is possible to effectively restrain the sealability in the through-hole 32H from decreasing due to the occurrence of cracks in the sealing member 50.

The above operations and effects can be obtained by using the following characteristic of a resin member such as rubber. That is, in a case where the volume of the resin member increases due to swelling, even when the deformation of the resin member to a given direction is restrained, the resin member is to deform to other directions at a similar swelling rate. The following describes this point more specifically.

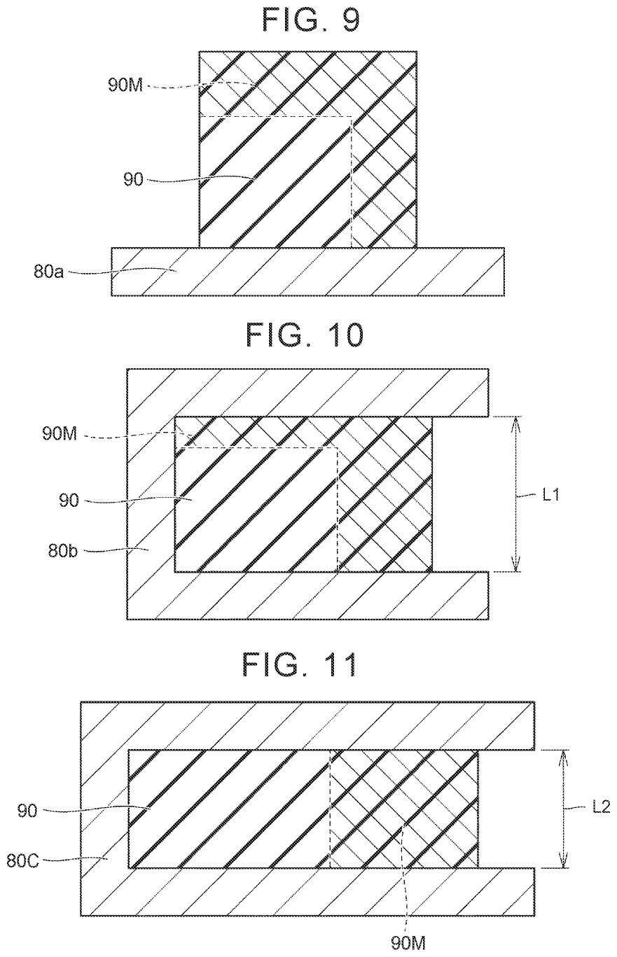

FIG. 9 is a sectional view illustrating a state where a sealing member 90 placed on a deformation restriction member 80a swells. Downward deformation of the sealing member 90 is restricted by the presence of the deformation restriction member 8a. In a state where a swelling portion 90M is formed in the sealing member 90, the sealing member 90 swells its volume to a direction where the deformation restriction member 80a is not present (in the example illustrated in FIG. 9, toward the upper direction, the left direction, and the right direction).

FIG. 10 is a sectional view illustrating a state where the sealing member 90 placed on a deformation restriction member 80b swells. In a state where the swelling portion 90M is formed in the sealing member 90, the sealing member 90 swells its volume to a direction where the deformation restriction member 80b is not present (in the example illustrated in FIG. 10, toward the right direction). In a case where the swelling rate of the sealing member 90 illustrated in FIG. 9 is 40%, for example, when the sealing members 90 in FIGS. 9, 10 are swollen under the same condition, the swelling rate of the sealing member 90 illustrated in FIG. 10 (a degree of a volume increase) is also 40% without being affected by the shape of the deformation restriction member 80b.

FIG. 11 is a sectional view illustrating a state where the sealing member 90 placed on a deformation restriction member 80c swells. In a state where the swelling portion 90M is formed in the sealing member 90, the sealing member 90 swells its volume to a direction where the deformation restriction member 80c is not present (in the example illustrated in FIG. 11, toward the right direction). An opening width L2 of the deformation restriction member 80c (FIG. 11) is smaller than an opening width L1 of the deformation restriction member 80b (FIG. 10). In a case where the swelling rates of the sealing members 90 illustrated in FIGS. 9, 10 are 40%, for example, when the sealing members 90 in FIGS. 9, 10, 11 are swollen under the same condition, the swelling rate of the sealing member 90 illustrated in FIG. 11 (a degree of a volume increase) is also 40% without being affected by the shape of the deformation restriction member 80c.

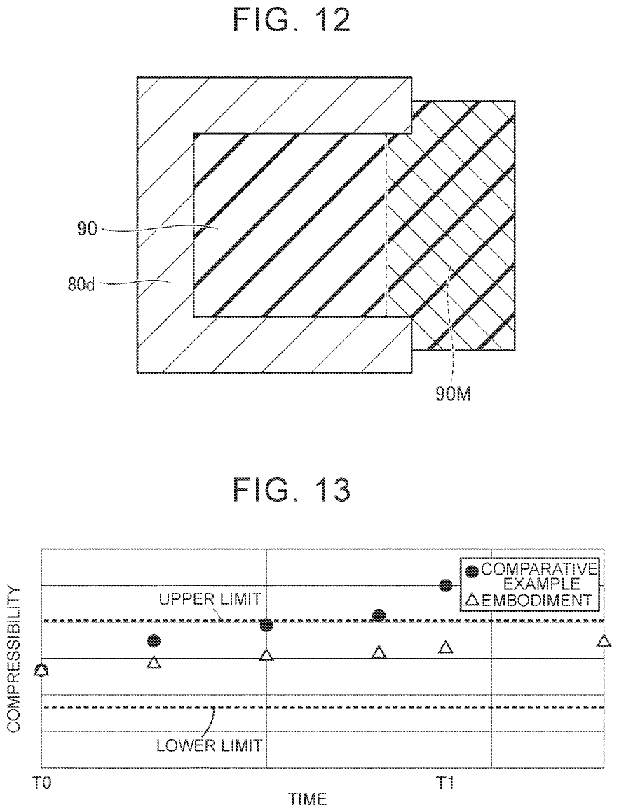

FIG. 12 is a sectional view illustrating a state where the sealing member 90 placed on a deformation restriction member 80d swells. In a state where the swelling portion 90M is formed in the sealing member 90, the sealing member 90 swells its volume to a direction where the deformation restriction member 80d is not present (in the example illustrated in FIG. 12, toward the right direction). Here, frictional force between the sealing member 90 and the deformation restriction member 80d is set to a smaller value, and a space for volume expansion is provided on the right side of the deformation restriction member 80d. Hereby, even in a case where the swelling rate of the sealing member 90 is 40%, for example, when a part of the sealing member 90 where the volume increases is placed inside the space, it is possible to effectively restrain the compression amount of the sealing member 90 from increasing.

The secondary battery 10 of the embodiment described in detail with reference to FIGS. 1 to 4 uses the above findings. With the technical idea described above, it is possible to provide the secondary battery 10 having a configuration that can restrain a decrease in sealability between the cover member 32 and the terminal member 40 by the sealing member 50.

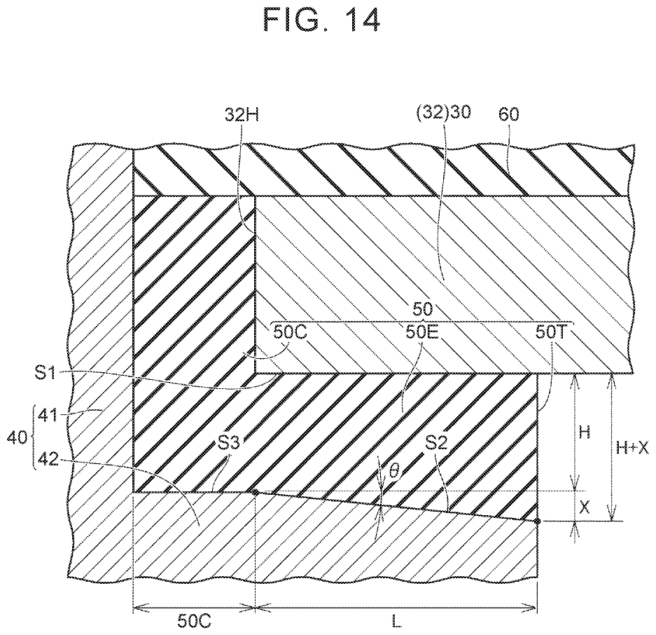

FIG. 13 is a graph illustrating how respective compressibilities of the sealing member based on the embodiment and the sealing member based on the comparative example change over time.

The sealing member 50 placed to be exposed to the electrolytic solution continues swelling with aging. Even in a case where the sealing member 50 swells, when the configuration that reduces frictional force like the embodiment is employed, it is possible to restrain a pressure from being applied to a part of the sealing member 50 that has an increased volume, and it is also possible to restrain the compressibility of the sealing member 50 from increasing as indicated as “EMBODIMENT.”

In the meantime, as indicated as “COMPARATIVE EXAMPLE,” in a case where frictional force remains high, when the compressibility of the sealing member 50 exceeds its upper limit (that is, when the sealing member 50 is brought into an over-compressed state), cracks occur in the sealing member 50. Based on the relationship between the time and the compressibility, a whole system including the sealing member 50 can be optimized.

Further, in the above embodiment, fluoro rubber that is more inexpensive than synthetic resin is used as the material for the sealing member 50, and this makes it possible to reduce the manufacturing cost. Since fluoro rubber has a feature that the fluoro rubber easily swells with respect to the electrolytic solution, it is possible to successfully achieve an advantage obtained by the operations and effects of the embodiment.

FIG. 14 is a sectional view to describe parameters of various dimensions and angles applicable to the second surface portion S2 of the terminal member 40 and a surrounding structure around the second surface portion S2. In a case where a plane parallel to the first surface portion S1 is defined, an angle formed between the plane and the second surface portion S2 is taken as a taper θ. The taper θ can be set to the following value.

As illustrated in FIG. 14, a thickness of the extending portion 50E after the compression is taken as a thickness H. A thickness of a part of the extending portion 50E that is provided on the exposed end portion 50T to expand from the thickness H toward the surface of the second surface portion S2 is taken as a thickness X. A thickness of the extending portion 50E on the exposed end portion 50T can be expressed as a thickness H+X.

A thickness of the extending portion 50E before the compression is taken as a thickness H1 (see FIG. 3). The extending portion 50E is provided to extend radially outside the tubular portion 50C, and the length of the extending portion 50E in the extending direction from the tubular portion 50C is taken as an effective seal long L of the extending portion 50E. The taper θ can be also defined as a taper angle from an effective sealing portion.

In terms of the taper angle θ, Formulae (1), (2) are provided as follows.

tan θ=(X/L) (1)

θ=tan⁻¹(X/L) (2)

In order to achieve, for example, a lower limit of 15% of designed compression when the thickness H1 of the extending portion 50E before the compression increases to the thickness (H+X) due to swelling, a compressibility Rₘᵢₙ is given by Formulae (3), (4) as follows.

Rₘᵢₙ=1+[H1+(H+X)]/H1 (3)

X=−H+(H1×Rₘᵢₙ) (4)

Accordingly, the taper θ can be defined by Formula (5) as follows.

θ=tan⁻¹[−X+H1×Rₘᵢₙ/L] (5)

The embodiment has been described as above. However, it should be noted that what is described herein is just an example in all respects and is not limitative. The scope of the present disclosure is shown by Claims and is intended to include all modifications made within the meaning and scope equivalent to Claims.

What is claimed is:

1. A secondary battery comprising:
an electrode body;
an electrolytic solution;
a case member inside which the electrode body and the electrolytic solution are accommodated, the case member having an opening;
a cover member having a through-hole, the cover member being placed to close the opening of the case member;
a terminal member electrically connected to the electrode body inside the case member, the terminal member being passed through the through-hole such that the terminal member is extended outwardly from the cover member; and
a sealing member placed to close a gap between the cover member and the terminal member, the sealing member being configured to prevent inside of the case member from communicating with outside of the case member via the through-hole, wherein:
the sealing member includes
an exposed end portion placed to be exposed inside the case member, and
an extending portion extending from the exposed end portion toward a position of the through-hole, the extending portion being compressed by the cover member and the terminal member;
the cover member includes a first surface portion;
the terminal member includes a second surface portion placed to face the first surface portion via a distance;
the first surface portion and the second surface portion are placed to compress the extending portion; and
the distance between the first surface portion and the second surface portion increases toward a position of the exposed end portion.

2. The secondary battery according to claim 1, wherein the sealing member is made of fluoro rubber.

3. The secondary battery according to claim 1, wherein:
the terminal member includes
a connecting portion passed through the through-hole, and
a flange portion provided at a position of a part of the connecting portion, the part being placed inside the case member, the second surface portion being formed on the flange portion;
the second surface portion of the flange portion is formed in a shape of a tapered surface; and
the tapered surface is formed such that a distance between the tapered surface and the first surface portion increases as the tapered surface is distanced from the connecting portion.

4. The secondary battery according to claim 3, wherein:
the sealing member includes a tubular portion placed between the through-hole and the connecting portion, the tubular portion being configured to surround the connecting portion; and
the extending portion is provided in a part of the tubular portion, the part being placed inside the case member.
